(19) United States
(12) Patent Application Publication
(10) Pub. No.: US 2003/0092302 A1
(43) Pub. Date: May 15, 2003

(54) O-ring removal slot

(76) Inventors: Christopher J. Conway, Wilmot, NH (US); Stewart Trent Adams, Plainfield, NH (US); Joseph P. Jones, Lebanon, NH (US)

Correspondence Address: Kelly K. Burris, Esq., Harness, Dickey & Pierce, P.L.C., Suite 400, 7700 Bonhomme Avenue, Saint Louis, MO, 63105, US

(21) Appl. No.: 10/039,943

(22) Filed: Nov. 9, 2001

(51) Int. Cl. H01R 13/52

(52) U.S. Cl. 439/271

(57) ABSTRACT

An o-ring removal slot is provided that adjoins an o-ring groove or o-ring shoulder disposed within a sealing member. Accordingly, the o-ring removal slot provides access to the o-ring groove or shoulder for removal of an o-ring disposed therein, and more particularly when the o-ring groove or shoulder are recessed such that access to the o-ring is restricted. Preferably, the o-ring removal slot is approximately perpendicular to the o-ring groove and extends between a distal end of the sealing member and the o-ring groove. In one form of the present invention, the sealing member is a negative lead gas carrying pin disposed within a quick disconnect to a power supply of a plasma arc cutting torch.

### FIELD OF THE INVENTION

The present invention relates generally to o-rings and more particularly to devices and methods to remove o-rings in a sealing member for inspection, replacement, or repair.

### BACKGROUND OF THE INVENTION

O-rings have been employed in a wide variety of systems for decades and have generally been used to seal an interface between two components, wherein the interface is sealed from fluids, e.g., gas or liquid, or a combination thereof. Generally, the o-ring is made of a flexible, resilient material, such as rubber or vinyl, and is typically seated within an o-ring groove or against an o-ring shoulder within one or both of the components, hereinafter referred to as sealing members. After extended periods of operation, an o-ring can become brittle and worn, and as a result, the interface between the sealing members develops leaks. Accordingly, an o-ring should be inspected and replaced periodically in order to maintain a fluid-tight interface between the sealing members.

In many systems of the known art, o-rings are typically installed and replaced manually. However, such o-rings may be relatively difficult to install and remove by hand when a limited amount of space exists proximate the sealing member and the o-ring. For example, the sealing member may be recessed within a housing such that access to the o-ring is limited, or the o-ring itself may be extremely small such that installation and/or removal by hand would not be possible. Accordingly, a number of o-ring installation and removal tools have been developed in the known art to install and remove o-rings that cannot, or are extremely difficult to, be removed by hand.

One such known art removal tool is disclosed in U.S. Pat. No. 5,564,175 to Nejad, wherein the tool comprises an elongated handle and a rounded tip. Generally, the rounded tip is inserted into an o-ring groove and under the o-ring for removal thereof by prying up with the elongated handle. Accordingly, the o-ring may be removed with the tool more easily than by hand. Similarly, U.S. Pat. No. 5,050,282 to Zannini discloses an o-ring insertion tool that is used to install an o-ring in a hidden, or inwardly facing, o-ring groove. The o-ring groove is inaccessible by hand, and thus the insertion tool comprises a flared end on a cylindrical shaft and a contact finger, wherein the o-ring is placed against the contact finger and a flange is engaged to slide the o-ring along the flared end and into the recessed o-ring groove for installation of the o-ring.

More specifically, in a typical plasma arc cutting apparatus that is manually operated, a connection between one or more pins that conduct electrical power and/or fluid, (e.g., gas, liquid), and one or more mating sockets exists within a quick disconnect between a torch lead and a power supply. Accordingly, a pin typically has an o-ring installed at a distal end thereof in order to seal the interface between the pin and a respective socket for a fluid-tight seal. In known art quick disconnects, the distal end of the pin extends beyond a housing of the connector, thereby leaving the pin and the o-ring exposed and prone to damage during installation and removal of different torch leads. If the pin and o-ring were to be recessed within the housing, however, the o-ring would be difficult to access, thus resulting in more difficult and time consuming inspection, repair, and/or replacement in the field. In other known art quick disconnects, the o-ring is installed against a shoulder deep within the mating socket, thus making removal of the o-ring relatively difficult and time consuming.

Although several insertion and removal tools have been developed for installing and removing o-rings, no features have yet been incorporated within the sealing members themselves to facilitate installation and removal of an o-ring therein. As a result, installation and removal of the o-ring is more difficult than necessary. Additionally, the use of installation and removal tools may cause damage to the o-ring itself if an operator does not take proper care during such installation and removal of the o-ring. Many known art tools comprise small, intricate features in order to engage the o-ring, which can cause damage to the o-ring when not used carefully.

Accordingly, there remains a need in the art for a sealing member that comprises certain features to facilitate removal of o-rings that are difficult to access within the sealing member. A further need exists for such features to maintain the liquid-tight and fluid-tight sealing integrity of the interface between sealing members.

### SUMMARY OF THE INVENTION

In one preferred form, the present invention provides a pin for use in a plasma arc apparatus that generally comprises an o-ring groove disposed around a cylindrical portion of the pin. Further, an o-ring removal slot is provided in the pin that adjoins the o-ring groove, such that the o-ring removal slot provides access for removal of an o-ring disposed within the o-ring groove. In one form, the o-ring groove is recessed within, for example, a plug housing in a quick disconnect to protect the pin during use. Therefore, the o-ring, which provides a fluid tight seal between the pin and a mating socket, is difficult to remove for inspection and/or replacement. Accordingly, the o-ring removal slot provides improved access to remove the o-ring from the recessed o-ring groove, using, for example, an o-ring removal tool.

In another form, the present invention provides a sealing member that comprises an o-ring groove disposed within the sealing member, and an o-ring removal slot adjoining the o-ring groove. Similarly, the o-ring removal slot provides access for removal of an o-ring disposed within the o-ring groove. Accordingly, the sealing member may be any of a number of components in a variety of systems such as fluid applications, e.g., fuel lines and connectors, or pneumatic applications, e.g. compressed air lines and connectors, among others. Furthermore, the o-ring groove may define a variety of geometrical profiles, including the cylindrical profile as further described herein with the embodiment of a pin in a plasma arc apparatus. Additionally, the o-ring groove and the o-ring removal slot may be disposed around an outer surface of the sealing member, e.g. outer diameter, or an inner surface of the sealing member, e.g. inner diameter.

In yet another form, the present invention provides a sealing member than comprises an o-ring shoulder disposed therein, rather than an o-ring groove. Similarly, the sealing member further comprises an o-ring removal slot that adjoins the o-ring shoulder, such that the o-ring removal slot provides access for removal of an o-ring disposed against the o-ring shoulder. Additionally, a plurality of o-ring removal slots may be provided within the sealing member or pin in accordance with the various forms of the present invention, rather than a single o-ring removal slot.

A method is also provided in accordance with the present invention, wherein an o-ring removal tool is engaged within an o-ring removal slot of a sealing member to remove an o-ring disposed therein. Generally, the o-ring removal tool engages the o-ring removal slot, advances along the o-ring removal slot, and then engages an o-ring disposed within the sealing member. Further, the o-ring removal tool removes the o-ring from the sealing member via the o-ring removal slot. Accordingly, the o-ring removal slot provides improved access for removal of the o-ring.

As used herein, a plasma arc apparatus shall be construed by those skilled in the art to be an apparatus, whether manual or automated, that generates or uses plasma for cutting, welding, spraying, or marking operations, among others. Accordingly, the specific reference to plasma arc cutting torches or plasma arc torches herein shall not be construed as limiting the scope of the present invention.

Further areas of applicability of the present invention will become apparent from the detailed description provided hereinafter. It shall be understood by those skilled in the art that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cutaway perspective view of an embodiment of an o-ring removal slot of a pin for use in a plasma arc apparatus constructed according to the principles of the present invention;

FIG. 2 is a top view of an embodiment of an o-ring removal slot within a pin for use in a plasma arc apparatus constructed according to the principles of the present invention;

FIG. 3 is a cross-sectional view, taken along plane A-A of FIG. 1, of an embodiment of a method of removing an o-ring via an o-ring removal slot according to the principles of the present invention; and

FIG. 4 is a cross-sectional view of an embodiment of an o-ring removal slot of a sealing member having an o-ring shoulder constructed according o the principles of the present invention.

### DETAILED DESCRIPTION OF THE PREFERRED EMBODIMENTS

The following description of the preferred embodiments is merely exemplary in nature and is in no way intended to limit the invention, its application, or uses.

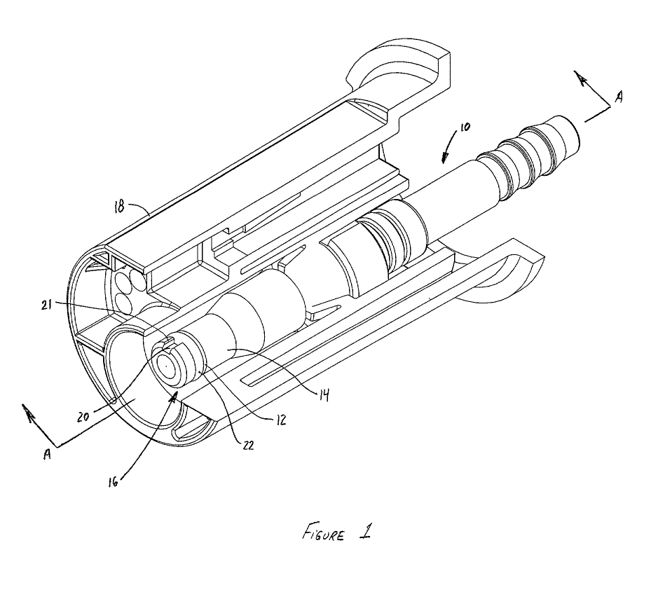

Referring to the drawings, a pin according to the present invention is illustrated and generally indicated by reference numeral 10 in FIG. 1. As shown, the pin 10 comprises an o-ring groove 12 disposed around a cylindrical portion 14 of the pin 10. Further, the cylindrical portion 14 is disposed at a distal end 16 of the pin 10, which is recessed inside a connector 18 in accordance with one form of the present invention. As further shown, the pin 10 also comprises an o-ring removal slot 20 adjoining the o-ring groove 12, which provides access for removal of an o-ring 22 disposed within the o-ring groove 12, using, for example, an o-ring removal tool (not shown).

The o-ring removal slot 20 may extend from the distal end 16 of the pin 10 as shown, or alternately, the o-ring removal slot 20 may extend to adjoin the o-ring groove 12 from an intermediate location along the pin 10. The depth of the o-ring removal slot 20 is preferably approximately the same depth as the o-ring groove 12, however, a shallower depth may also be employed in accordance with the teachings of the present invention. Furthermore, the o-ring removal slot 20 may have a non-constant depth along its length from the distal end 16 of the pin 10, or an intermediate location along the pin 10, to the o-ring groove 12. For example, the o-ring removal slot 20 may be deeper towards the o-ring groove 12 than at the distal end 16 of the pin 10.

Additionally, the o-ring removal slot 20 is sized appropriately such that the sealing function of the o-ring 22 is not adversely affected. For example, in one form of the present invention, the o-ring removal slot 20 is approximately 0.0625 in. (0.1588 mm) wide, approximately 0.031 in. (0.080 mm) deep, and approximately 0.094 in. (0.238 mm) long with an o-ring groove 12 diameter of approximately 0.20 in. (0.52 mm). Accordingly, the sealing integrity of the o-ring 22 is not adversely affected with the presence of the o-ring removal slot 20.

Generally, the pin 10 engages a main power socket (not shown) disposed within a power supply (not shown), and the o-ring 22 provides a fluid-tight seal between the pin 10 and the main power socket when the torch lead is connected to a power supply (not shown) of a plasma arc cutting apparatus. Preferably, the pin 10 is a negative lead gas carrying pin and comprises of a brass material. Additionally, the connector 18 is a plug housing, which is connected to the torch lead side of a connection between the torch lead and the power supply of a plasma arc cutting torch in one form of the present invention.

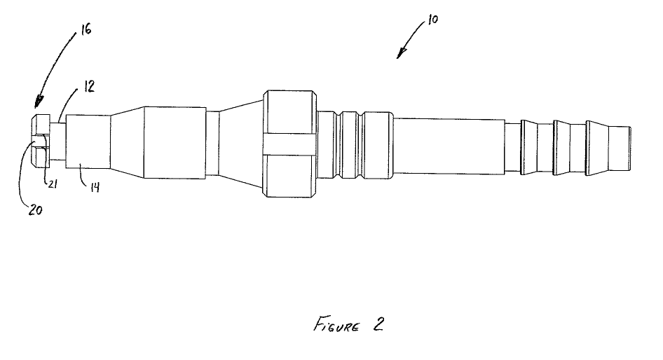

Referring also to FIG. 2, wherein the o-ring 22 is omitted for clarity, the o-ring removal slot 20 in one form is approximately perpendicular to the o-ring groove 12 as illustrated, although other orientations such as a spiral groove that adjoins the o-ring groove 12 at an angle, may also be employed in accordance with the teachings of the present invention. Further, the o-ring removal slot 20 extends between the distal end 16 of the pin 10 and the o-ring groove 12, such that an o-ring removal tool may be inserted into the connector 18 proximate the recessed pin 10 to engage the o-ring removal slot 20 and thus remove the o-ring 22 disposed within the o-ring groove 12.

As further shown, the o-ring removal slot 20 also comprises chamfered edges 21 that extend between the o-ring groove 12 and the distal end 16 of the pin 10. Accordingly, the chamfered edges 21 eliminate an otherwise sharp edge that could damage the o-ring 22 during either removal for inspection or replacement thereof.

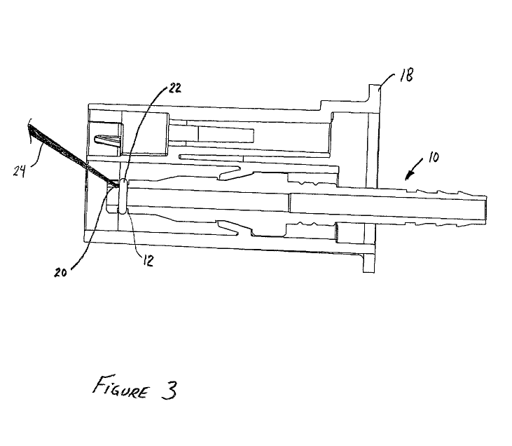

As shown in FIG. 3, an o-ring removal tool 24 engages the o-ring removal slot 20 and is then advanced along the o-ring removal slot 20 to engage the o-ring 22 disposed within the o-ring groove 12. Accordingly, the o-ring removal tool 24 removes the o-ring 22 via the o-ring removal slot 20 as shown. As a result, the o-ring 22 is removed more easily since greater access thereto is gained through the o-ring removal slot 20, especially if the o-ring groove 12 is recessed within the connector 18 as previously described. As a result, the o-ring 22 may be removed relatively quickly while minimizing any damage to both the o-ring 22 as well as the pin 10 from engagement of the o-ring removal tool 24. Additionally, a plurality of o-ring removal slots 20 may be disposed within the pin 10 rather than only one o-ring removal slot 20 as described herein, such that at least one o-ring removal tool engages a plurality of o-ring removal slots to remove the o-ring 22.

In another form of the present invention, the o-ring removal slot 20 is employed in a generic sealing member rather than the specific pin 10 as described above. The sealing member may be any number of components in a variety of systems such as fluid applications, e.g., fuel lines and connectors, or pneumatic applications, e.g. compressed air lines and connectors, among others. The sealing member similarly comprises an o-ring groove with an o-ring removal slot adjoining the o-ring groove. Accordingly, the o-ring removal slot provides access for removal of the o-ring disposed within the o-ring groove as previously described. Additionally, the o-ring groove may be disposed around an outer surface (e.g., outer diameter) of the sealing member or around an inner surface (e.g., inner diameter) of the sealing member according to the configuration of the sealing member. Moreover, a plurality of o-ring removal slots may be employed rather than a single o-ring removal slot.

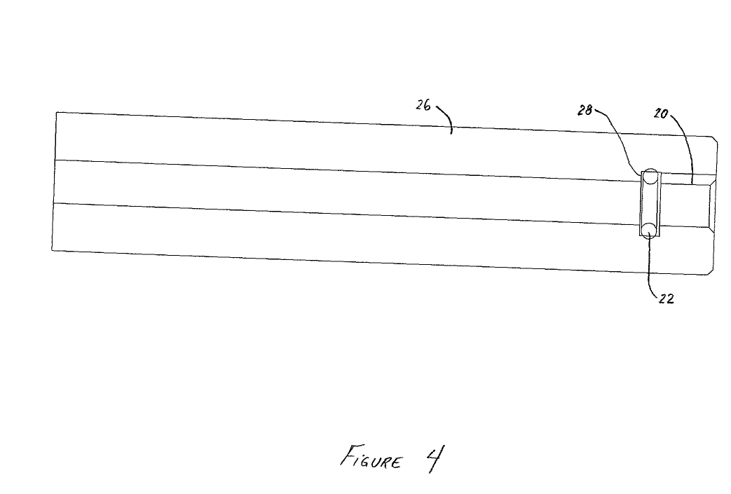

Referring now to FIG. 4, the o-ring removal slot 20 is employed in a sealing member 26 in yet another form of the present invention, wherein the o-ring removal slot 20 adjoins a shoulder 28 rather than an o-ring groove 12 as previously described. As shown, the o-ring 22 is disposed against the shoulder 28 to seal an interface between the sealing member 26 and an adjacent sealing member (not shown). Accordingly, the o-ring removal slot 20 provides access for removal of the o-ring 22. Additionally, the o-ring removal slot 20 is approximately perpendicular to the o-ring shoulder 28, although other orientations, such as a spiral that adjoins the shoulder 28 at an angle, may be employed in accordance with the teachings of the present invention. Furthermore, the o-ring removal slot 20 may have a constant or non-constant depth, which is sized according to the specific application so as to maintain the sealing integrity of the o-ring 22.

In one form, the sealing member 26 may be a main power socket as previously described with the shoulder 28 disposed therein. Accordingly, the o-ring 22 provides a fluid-tight seal between the main power socket and a negative lead gas carrying pin in a plasma arc cutting apparatus. Similarly, a plurality of o-ring removal slots 20 may be employed rather than a single o-ring removal slot 20 as described herein.

Accordingly, a pin and sealing member are disclosed that provide improved access for removal of o-rings disposed therein, along with associated methods for removal of the o-rings. As a result, o-rings can be removed more easily while reducing the risk of damage to both the o-ring and the pin or sealing member from the use of o-ring removal tools.

The description of the invention is merely exemplary in nature and, thus, variations that do not depart from the substance of the invention are intended to be within the scope of the invention. Such variations are not to be regarded as a departure from the spirit and scope of the invention.

What is claimed is:

1. A pin for use in a connector of a plasma arc apparatus, the pin comprising:
a cylindrical portion disposed at a distal end of the pin;
an o-ring groove disposed around the cylindrical portion; and
an o-ring removal slot adjoining the o-ring groove,
wherein the o-ring removal slot provides access for removal of an o-ring disposed within the o-ring groove.

2. The pin of claim 1, wherein the o-ring groove is recessed within a housing of the connector.

3. The pin of claim 2, wherein the housing is a plug housing connected to a torch lead of the plasma arc cutting apparatus.

4. The pin of claim 1, wherein the o-ring removal slot is approximately perpendicular to the o-ring groove.

5. The pin of claim 1, wherein the o-ring removal slot extends between the distal end of the pin and the o-ring groove.

6. The pin of claim 1, wherein the o-ring removal slot further comprise chamfered edges.

7. The pin of claim 1 further comprising a plurality of o-ring removal slots.

8. The pin of claim 1, wherein the pin is a negative lead gas carrying pin.

9. The pin of claim 1, wherein the pin comprises a brass material.

10. A negative lead gas carrying pin for use in a connector of a plasma arc apparatus, the negative lead gas carrying pin comprising:
a cylindrical portion disposed at a distal end of the negative lead gas carrying pin;
an o-ring groove disposed around the cylindrical portion; and
an o-ring removal slot adjoining the o-ring groove,
wherein the o-ring removal slot provides access for removal of an o-ring disposed within the o-ring groove.

11. The negative lead gas carrying pin of claim 10, wherein the o-ring groove is recessed within a housing of the connector.

12. The negative lead gas carrying pin of claim 12, wherein the housing is a plug housing connected to a torch lead of the plasma arc cutting apparatus.

13. The negative lead gas carrying pin of claim 10, wherein the o-ring removal slot is approximately perpendicular to the o-ring groove.

14. The negative lead gas carrying pin of claim 10, wherein the o-ring removal slot extends between the distal end of the negative lead gas carrying pin and the o-ring groove.

15. The negative lead gas carrying pin of claim 10, wherein the o-ring removal slot further comprises chamfered edges.

16. The negative lead gas carrying pin of claim 10 further comprising a plurality of o-ring removal slots.

17. The negative lead gas carrying pin of claim 10, wherein the negative lead gas carrying pin comprises a brass material.

18. A sealing member comprising:
an o-ring groove disposed within the sealing member; and
an o-ring removal slot adjoining the o-ring groove,
wherein the o-ring removal slot provides access for removal of an o-ring disposed within the o-ring groove.

19. The sealing member of claim 18 further defining a cylindrical portion disposed at a distal end of the sealing member, wherein the o-ring groove is disposed around the cylindrical portion proximate the distal end.

20. The sealing member of claim 19, wherein the o-ring removal slot extends between the distal end of the sealing member and the o-ring groove.

21. The sealing member of claim 18, wherein the o-ring removal slot further comprises chamfered edges.

22. The sealing member of claim 18, wherein the o-ring groove is recessed within an adjacent sealing member.

23. The sealing member of claim 18, wherein the o-ring groove is disposed around an outer surface of the sealing member.

24. The sealing member of claim 18, wherein the o-ring groove is disposed around an inner surface of the sealing member.

25. The sealing member of claim 18, wherein the o-ring removal slot is approximately perpendicular to the o-ring groove.

26. The sealing member of claim 18 further comprising a plurality of o-ring removal slots.

27. A sealing member comprising:
an o-ring shoulder disposed within the sealing member; and
an o-ring removal slot adjoining the o-ring shoulder,
wherein the o-ring removal slot provides access for removal of an o-ring disposed against the o-ring shoulder.

28. The sealing member of claim 27, wherein the o-ring removal slot is approximately perpendicular to the o-ring shoulder.

29. The sealing member of claim 27, wherein the o-ring removal slot further comprises chamfered edges.

30. The sealing member of claim 27, wherein the sealing member is a main power socket for use in a plasma arc cutting apparatus.

31. The sealing member of claim 27 further comprising a plurality of o-ring removal slots.

32. A method of removing an o-ring from a sealing member, the method comprising the steps of:
(a) engaging an o-ring removal tool within an o-ring removal slot of the sealing member;
(b) advancing the o-ring removal tool along the o-ring removal slot; and
(c) engaging the o-ring removal tool with the o-ring to remove the o-ring via the o-ring removal slot,
wherein the o-ring removal slot provides improved access for removal of the o-ring.

33. The method of claim 32, wherein the sealing member is a negative lead gas carrying pin for use in a plasma arc cutting apparatus.

34. The method of claim 32, wherein the sealing member is a main power socket for use in a plasma arc cutting apparatus.

35. The method of claim 32 further comprising the step of engaging at least one o-ring removal tool with a plurality of o-ring removal slots.
